(19) United States
(12) Patent Application Publication
(10) Pub. No.: US 2007/0179757 A1
(43) Pub. Date: Aug. 2, 2007

(54) Architectural structure design methods, architectural structure design apparatuses and articles of manufacture

(75) Inventor: Jack Simpson, Coeur D'Alene, ID (US)

Correspondence Address: WELLS ST. JOHN P.S., 601 W. FIRST AVENUE, SUITE 1300, SPOKANE, WA, 99201, US

(73) Assignee: Chief Architect, Inc.

(21) Appl. No.: 11/332,048

(22) Filed: Jan. 13, 2006

(51) Int. Cl. G06F 17/50

(52) U.S. Cl. 703/1

(57) ABSTRACT

Architectural structure design methods, apparatuses and articles of manufacture are described according to some aspects of the disclosure. In one aspect, an architectural structure design apparatus includes accessing a design of an architectural structure, accessing information regarding a location of the design of the architectural structure, designing an object using the information regarding the location, modifying the design of the architectural structure to include the object, and after the modifying, displaying the design of the architectural structure comprising the object.

### TECHNICAL FIELD

This disclosure relates to architectural structure design methods, architectural structure design apparatuses and articles of manufacture.

### BACKGROUND

Personal computing devices are ubiquitous at homes, schools and the workplace. The ever-increasing capabilities and functions provided by computing devices have led to their usage in numerous applications. Some applications for computing devices have been introduced to assist users with design and visualization of architectural structures, such as residential homes, offices, etc. These applications have been designed to generate structural designs, to facilitate modifications of structural designs and to provide visual representations of structures defined by the designs. At least some aspects of the disclosure describe apparatus, methods and articles of manufacture which may further facilitate generation and modification of architectural structural designs.

### BRIEF DESCRIPTION OF THE DRAWINGS

Embodiments of the disclosure are described below with reference to the following accompanying drawings.

FIG. 1 is a block diagram of an architectural structure design apparatus according to one embodiment.

FIG. 2 is an illustrative representation of an image generated by a display screen according to one embodiment.

FIGS. 3A-3B are illustrative representations of additional images generated by a display screen according to one embodiment.

FIGS. 4A-4B are illustrative representations of additional images generated by a display screen according to one embodiment.

FIG. 5 is a flow chart of an exemplary method according to one embodiment.

### DETAILED DESCRIPTION

According to one embodiment of the disclosure, an architectural structure design method comprises accessing a design of an architectural structure, accessing information regarding a location of the design of the architectural structure, designing an object using the information regarding the location, modifying the design of the architectural structure to include the object, and after the modifying, displaying the design of the architectural structure comprising the object.

According to an additional embodiment of the disclosure, architectural structure design apparatus comprises a display configured to depict a design of an architectural structure, a user interface configured to receive user input, and processing circuitry coupled with the display and the user interface, wherein the processing circuitry is configured to control the display to depict the design of the architectural structure at a first moment in time, to access one of the user inputs indicative of a desire of the user to insert a dormer into the design of the architectural structure at a second moment in time after the first moment in time, to access information regarding the dormer and information regarding the design of the architectural structure responsive to the accessing the one of the user inputs, to modify the design of the architectural structure to include the dormer, and to control the display to depict the design of the architectural structure including the dormer at a third moment in time after the first and second moments in time.

According to another embodiment, an article of manufacture comprises media comprising programming configured to cause processing circuitry to perform processing comprising: controlling a display to depict a design of an architectural structure at a first moment in time; accessing user input identifying a location of the design of the architectural structure for placement of a dormer; accessing information regarding the dormer; identifying portions of the architectural structure to be modified using the location and the information regarding the dormer; modifying the portions of the design of the architectural structure to integrate the dormer with the design of the architectural structure, and controlling the display to depict the design of the architectural structure having the dormer at a second moment in time after the first moment in time.

According to exemplary embodiments, an architectural structure design apparatus and methods are configured to facilitate design, creation and/or modification of architectural structures. In some illustrative examples described further below, architectural structure design apparatus and methods are configured to facilitate design and/or integration of objects, such as dormers, within designs of architectural structures.

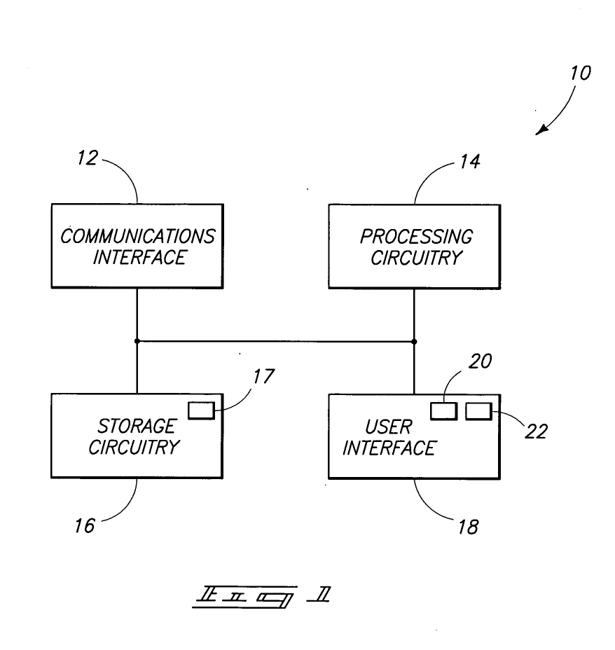

Referring to FIG. 1, an architectural structure design apparatus 10 is illustrated according to one embodiment. The illustrated exemplary architectural structure design apparatus 10 includes a communications interface 12, processing circuitry 14, storage circuitry 16, and a user interface 18. For example, in exemplary embodiments, apparatus 10 may be embodied as a personal computer (PC) utilizing a Windows® Operating System available from Microsoft Corporation, a Macintosh® computer available from Apple Computer, Inc., a work station, or other suitable configuration. Further, other configurations of architectural structure design apparatus 10 are possible in other embodiments including more, less and/or alternative components.

Communications interface 12 is arranged to implement communications of architectural structure design apparatus 10 with respect to external devices and/or networks (not shown). For example, communications interface 12 may be arranged to communicate information bi-directionally with respect to architectural structure design apparatus 10. Communications-interface 12 may be implemented as a network interface card (NIC), serial or parallel connection, USB port, Firewire interface, flash memory interface, floppy disk drive, or any other suitable arrangement for communicating with respect to architectural structure design apparatus 10.

In one embodiment, processing circuitry 14 is arranged to process data, control data access and storage, issue commands, and control other desired operations of apparatus 10. Processing circuitry 14 may comprise circuitry configured to implement desired programming provided by appropriate media in at least one embodiment. For example, the processing circuitry 14 may be implemented as one or more of a processor or other structure configured to execute executable instructions including, for example, software or firmware instructions, and/or hardware circuitry. Exemplary embodiments of processing circuitry 14 include hardware logic, PGA, FPGA, ASIC, state machines, or other structures. alone or in combination with a processor. These examples of processing circuitry 14 are for illustration and other configurations are possible.

The storage circuitry 16 is configured to store programming such as executable code or instructions (e.g., software or firmware), electronic data, databases, or other digital information, and may include processor-usable media. Processor-usable media may be embodied in any computer program product or article of manufacture 17 which can contain, store, or maintain programming, data or digital information for use by or in connection with an instruction execution system including processing circuitry 14 in the exemplary embodiment. For example, exemplary processor-usable media may include any one of physical media such as electronic, magnetic, optical, electromagnetic, infrared or semiconductor media. Some more specific examples of processor-usable media include, but are not limited to, a portable magnetic computer diskette, such as a floppy diskette, zip disk, hard drive, random access memory, read only memory, flash memory, cache memory, or other configurations capable of storing programming, data, or other digital information.

At least some embodiments or aspects described herein may be implemented using programming stored within appropriate storage circuitry 16 described above or communicated via a network or other transmission media and configured to control appropriate processing circuitry 14. For example, programming may be provided via appropriate media including, for example, embodied within articles of manufacture 17, embodied within a data signal (e.g., modulated carrier wave, data packets, digital representations, etc.) communicated via an appropriate transmission medium, such as a communication network (e.g., the Internet or a private network), wired electrical connection, optical connection or electromagnetic energy, for example, via communications interface 12, or provided using other appropriate communication structure or medium. Exemplary programming including processor-usable code may be communicated as a data signal embodied in a carrier wave in but one example.

User interface 18 is configured to interact with a user including receiving user input and/or conveying information to a user. In the depicted embodiment, user interface 18 includes an input device 20 and an output device 22. An exemplary input device 20 is arranged to receive tactile input from a user and may be embodied as a keyboard and/or mouse. Further, output device 22 is configured to convey information to a user and may be embodied as a display (e.g., monitor) configured to depict visual images for observation by a user. Other configurations of user interface 18 are possible in other embodiments.

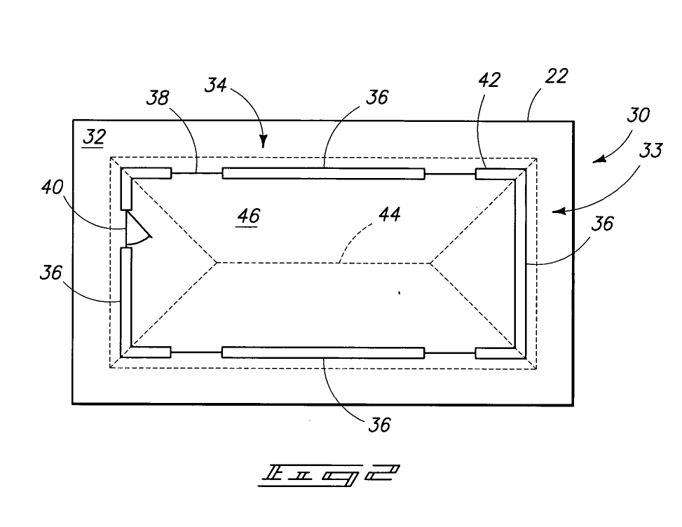

Referring to FIG. 2, an exemplary image 30 generated using a display screen of output device 22 is shown. In FIG. 2, the display screen may correspond to the box associated with reference 22.

The depicted image 30 includes a workspace 32 and a visual representation 33 of an architectural structure. Image 30 may be provided within an application window (not shown in FIG. 2) in one embodiment. Visual representation 33 may correspond to a design of an architectural structure (e.g., the architectural structure being modified by a user) and the design is in the form of a building plan 34 in the example of FIG. 2. Workspace 32 may be used for drawing or modifying images, such as building plan 34. Building plan 34 may refer to a plan view representation of an architectural structure in one embodiment although the architectural structure may be represented in other representations or views in other embodiments. For example, a user may select visual representations 33 of interior views (e.g., perspective, isometric, side), exterior views (e.g., perspective, isometric, side), or any other views desired with respect to the architectural structure being processed.

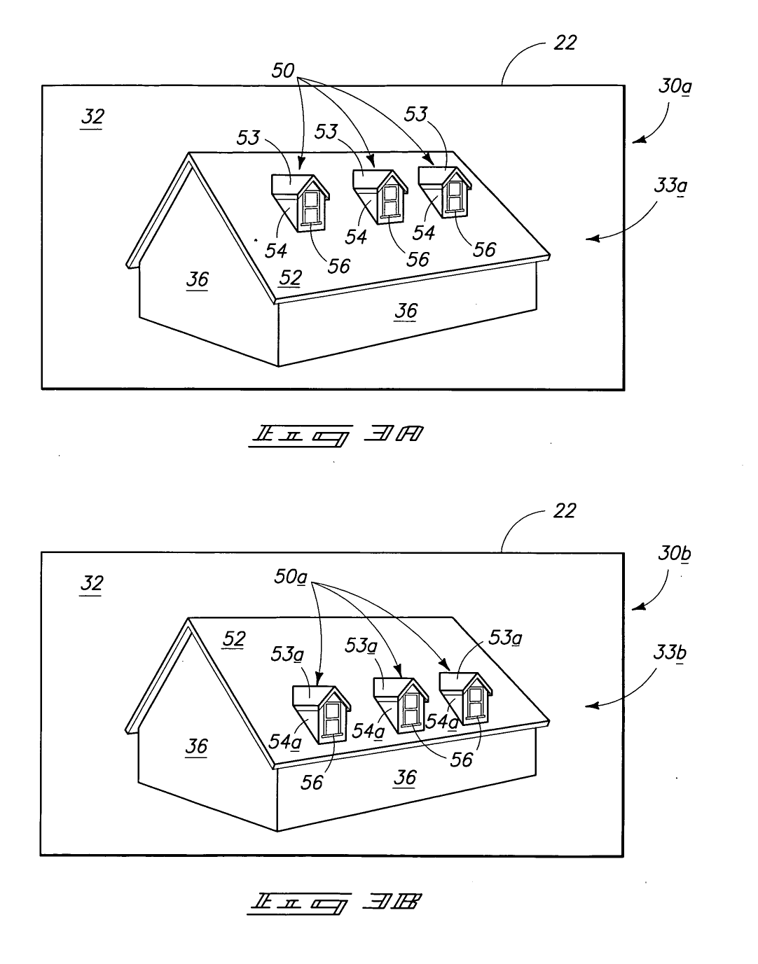

A user may manipulate input device 20 to create visual representations 33 of an architectural structure in one embodiment. In another embodiment, a file of a previously generated visual representation 33 may be accessed from storage circuitry 16 or other source and used to create images 30. A user may interact with the building plan 34 to implement desired modifications and/or additions. In addition, a user may interact with other views of designs of architectural structures, for example, as described with respect to FIGS. 3A-3B below.

As mentioned above, the depicted exemplary building plan 34 corresponds to an architectural structure, such as a house, although other structures may be generated and/or modified. A user may configure visual representations 33 of an architectural structure to include a plurality of objects. According to one embodiment, objects may comprise structures or components which may be moved and/or manipulated by a user within a visual representation 33 and may include a plurality of separately identifiable subcomponents.

In one embodiment, the subcomponents of a given object may be associated with one another to form an object, for example, and information regarding assembly of the subcomponents to form an object may be stored within a library of the storage circuitry 16. Accordingly, in one implementation, the subcomponents may be predefined and arranged to form a predefined object (e.g., defined at a moment in time prior to selection of the object for inclusion within a design of an architectural structure). The library may specify how the subcomponents are to be arranged to form the respective objects according to default and/or user defined configurations and processing circuitry 14 may generate and assemble the subcomponents corresponding to the stored specifications in one embodiment. A user may select the object for inclusion in a visual representation 33 without having to construct the object itself by arranging the subcomponents according to one operational embodiment. In an additional aspect, a user may select and manipulate an object (e.g., insert an object into a design and/or move the object to different locations within a design) without selecting and manipulating the individual subcomponents of the object. Further, a user may selectively change one or more subcomponent of an object in one embodiment. For example, a user may change or modify properties and/or dimensions of one or more of the subcomponents of an object if desired.

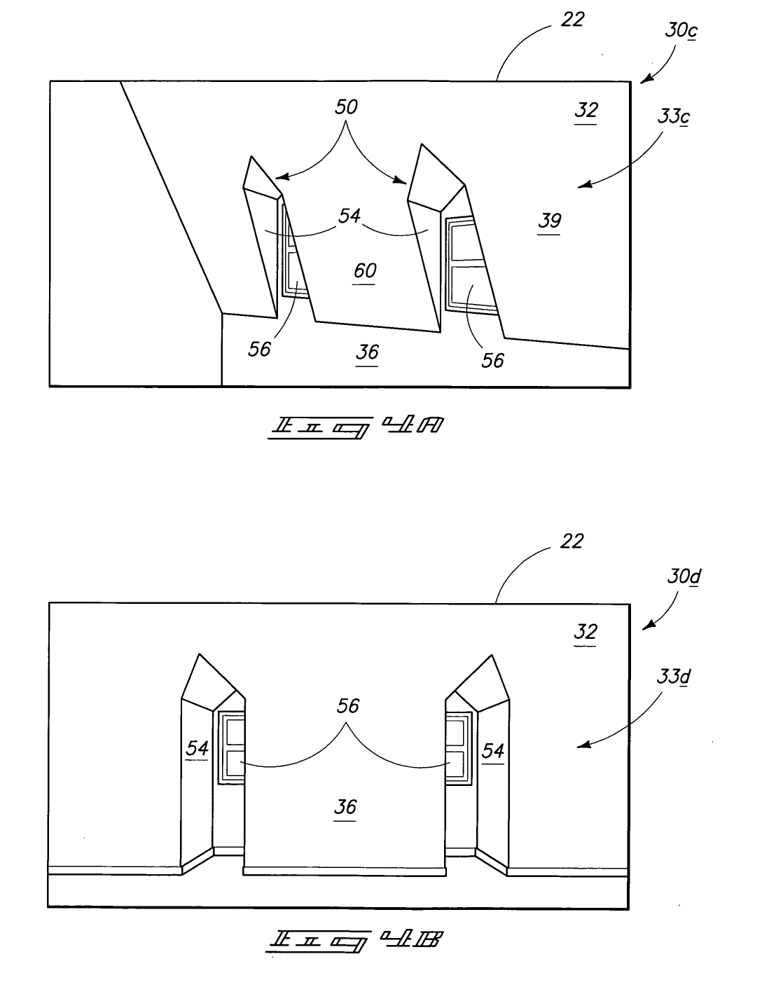

Some embodiments of the present disclosure facilitate generation and/or integration of objects with respect to a design of an architectural structure. In one specific example described in further detail below, architectural structure design apparatus 10 is configured to facilitate generation and/or integration of objects comprising dormers (e.g., an exemplary dormer object may include a plurality of walls, a window and a roof) into designs of architectural structures. In other embodiments, other objects may also be generated and/or integrated into designs of architectural structures and may include bay or box windows for example. Exemplary aspects of dormer generation and integration are discussed below with respect to FIGS. 3A-3B and FIGS. 4A-4B although other objects may be generated and/or integrated in other embodiments.

Referring again to FIG. 2, exemplary objects of a design of an architectural structure may include walls 36, windows 38, and a door 40 in the illustrated example. As mentioned above, additional objects are possible and may include additional structures commonly designed with respect to architectural structures and which may include a plurality of subcomponents. For example, additional objects may include cabinets, counters, light fixtures, bathroom fixtures, floors, and ceilings.

A user may draw the walls 36 of building plan 34 to create a design of an architectural structure by using input device 20 comprising a mouse and similar to drawing on paper in one example. A user may also modify existing designs of an architectural structure. For example, a user may modify a configuration of a design of an architectural structure by moving, adding or deleting objects. In one example, a user may add objects such as interior walls (not shown) to the building plan 34. In one embodiment, the design of the architectural structure may be continually displayed via output device 22 and reflect modifications in real time as entered by a user and/or determined by processing circuitry 14 in one embodiment.

Referring to FIGS. 3A-3B, other exemplary images 30a, 30b generated by output device 22 according to exemplary embodiments are shown. The illustrated images 30a, 30b include other visual representations 33a, 33b of designs of architectural structures both depicted using a display screen of output device 22 (e.g., the boxes associated with reference 22 of FIGS. 3A-3B may again correspond to the display screen of the output device). The below examples are described with respect to generation and/or integration of objects including dormers in the described embodiment although the described aspects are applicable to other objects in other embodiments.

The exemplary visual representations 33a, 33b are in the form of exterior perspective views of designs of an architectural structure including floating dormers 50 (FIG. 3A and FIG. 4A) and non-floating dormers 50a (FIG. 3B and FIG. 4B). In one embodiment, floating dormers 50 refer to dormers which sit on roof 52 and the front and side walls of the dormers 50 are cut off by the roof 52. Further, sizes of holes through roof 52 correspond to dimensions of the interiors of the front and side walls of the respective dormers 50. Non-floating dormers 50a may refer to dormers where the associated front and side walls of the dormer pass through roof 52 to the floor of a corresponding interior room. The corresponding holes within roof 52 may be sized to the exterior dimensions of the front and side walls of the dormers 50a to accommodate the walls thereof. In one embodiment, front walls of dormers 50, 50a may be aligned with (e.g., co-planar) with a respective wall of the design of the architectural structure. Also, in other embodiments, dormers 50 may refer to non-floating dormers and dormers 50a may refer to floating dormers. As described below, architectural structure design apparatus 10 may facilitate the generation and/or integration of floating or non-floating dormers 50, 50a within designs of architectural structures in exemplary embodiments. Although three dormers 50, 50a are respectively shown in FIGS. 3A-3B, other numbers including less or more numbers of dormers 50, 50a may be provided in other designs in other arrangements.

In one exemplary configuration, a user may request a view of a design appropriate for implementing operations with respect to the objects to be integrated. As shown in FIGS. 3A-3B, one possible view is an exterior perspective view of the design of the architectural structure being created and/or modified. In addition to selection of the described view, a user may indicate to apparatus 10 that they wish to enter into a mode for automatically generating and/or integrating an object, such as a dormer 50, 50a, into a design of an architectural structure. For example, a user may click an appropriate icon to provide the apparatus 10 into the desired mode.

Processing circuitry 14 may access information regarding the object to be integrated into the design of architectural structure in one embodiment. In one illustrative example, processing circuitry 14 may access a library of objects in storage circuitry 16 to access information of the requested object, for example, including specifications for a defined arrangement of the subcomponents of the object. The accessed design for the object may be specified by default and/or user defined properties in one exemplary configuration (e.g., properties of the dormers including the types of roofs and windows of dormers 50, 50a may be default or user specified). In one example, information accessed from the library may include at least some dimensions of the dormers 50, 50a. For example, the dimensions of a front surface of the dormers 50, 50a including the window may be provided by the library (e.g., default size of the rectangular dormer front surface of 60″ H×48″ W) and additional details of the dormer 50, 50a being designed and integrated (e.g., details regarding walls 54) may be determined using information of the design of the architectural structure (e.g., pitch of roof 52) as discussed further below. A user may modify dimensions of the dormers 50, 50a of the library if desired.

Thereafter, a user may manipulate user input 20 (e.g., a mouse) to select one or more locations for placement of one or more dormers 50, 50a. In one embodiment, a location of roof plane of roof 52 may be clicked where the user wishes to place the center of the front wall of the dormer 50, 50a. In another embodiment, processing circuitry 14 may automatically determine the location of one or more dormers 50, 50a without user input specifying the location. For example, default settings may be made such as centering a dormer 50, 50a with respect to an interior room having the dormer 50, 50a, centering a dormer 50, 50a according to an exterior wall, according to an applicable building code or according to other desired criteria.

After proper locations for placement of the dormers 50, 50a are identified, the processing circuitry 14 may extract information regarding the respective locations of the existing design of the architectural structure. The information may be used in designing the object and integrating the object into the design of the architectural structure in illustrative examples. Processing circuitry 14 may also identify and modify existing portions of the design of the architectural structure to be modified to accommodate the dormers 50, 50a at the selected locations in one embodiment.

For example, in one illustrative embodiment, the processing circuitry 14 may access information regarding the pitch of a roof 52 at the locations where the dormers 50, 50a will be placed. Using the pitch information, additional details of the dormers 50, 50a may be designed (e.g., the length of a ridge of the dormer roofs 53, 53a may be calculated as well as the corresponding sizes of walls 54, 54a of the dormers 50, 50a). Similarly, as illustrated below with respect to FIGS. 4A and 4B, information from the design of the architectural structure and the dormers 50, 50a may be used to design interior portions of the dormers 50, 50a, such as interior dimensions of the walls 54, 54a.

Processing circuitry 14 may generate the dormers 50, 50a using the information accessed from the library with respect to dormers 50, 50a as well as information accessed from the design of the architectural structure. In one embodiment, the processing circuitry 14 may initially define aspects of the walls 54, 54a (e.g., spacing of the walls 54, 54a of an individual dormer 54, 54a from one another) using the accessed information. Thereafter, the accessed information may be used to create additional aspects of the dormers 54, 54a such as roof planes of the dormer roof 53 designed according to the desired properties of the dormers 50, 50a (e.g., gable). Further, the intersections of the dormer roof 53 and base roof 52 may be identified and defined. The dormer walls 54 may be defined to extend between base roof 52 and dormer roof 53. A hole may be made within roof 52 having dimensions corresponding to the internal dimensions of the walls 54 at locations of the intersections of the walls 54 with base roof 52. Windows 56 for the respective dormers 50, 50a may thereafter be added at appropriate locations corresponding to the designs of the respective dormers 50, 50a to be generated.

Using information of the designed dormers 50, 50a (e.g., such as dimensions of the dormers 50, 50a) and information of the designs of the architectural structures, processing circuitry 14 may identify portions of the designs of the architectural structures which may be impacted by the integration of the dormers 50, 50a and corresponding to the selected locations for integration of the dormers 50, 50a. For one exemplary exterior modification, exterior portions of roof 52 may be identified to be replaced by the dormers 50, 50a. The processing circuitry 14 may delete portions of the roof 52 at the respective locations and replace the deleted portions of the roof 52 with the dormers 50, 50a.

Referring to FIGS. 4A-4B, the illustrated images 30c, 30d include other visual representations 33c, 33d of designs of architectural structures both depicted using a display screen of output device 22 (e.g., the boxes associated with reference 22 of FIGS. 4A-4B may again correspond to the display screen of the output device). As shown, interior portions of designs of architectural structures may also be impacted by the inclusion of dormers 50, 50a. Floating dormers 50 are basically complex skylights in ceiling 39 which may sit upon respective holes in the roof 52 defined by the dimensions of the dormers 50 and the locations of the dormers 50. Furthermore, typically no interior rooms of the designs of the architectural structures are defined by the walls of floating dormers 50.

Processing circuitry 14 may access information regarding positions of framing, interior walls, ceilings, and/or attics of a design of an architectural structure corresponding to the locations selected by the user for dormer placement and the dimensions of the dormers 50 in illustrative examples. Using the information regarding the interior portions of the design and the information regarding the dimensions and locations of dormers 50, processing circuitry 14 may identify specific modifications to the interior portions of the design of the architectural structure to integrate the dormers 50. For example, modifications to ceiling 60 are evident in FIG. 4A at locations of the ceiling 60 corresponding to the placement of the dormers 50. Walls 54 may extend inwardly from the front exterior portions of the dormers 50 to the respective intersections with ceiling 60. Portions of the ceiling 60 corresponding to the intersections with the walls 54 of the dormers 50 may be identified and replaced with interior details of the design of the dormers 50 as shown. Furthermore, internal framing (not shown) may be modified as appropriate during integration of the dormers 50 (e.g., a framing member may be moved by processing circuitry 14 to accommodate a dormer 50). Other modifications may be identified and made by processing circuitry in other examples. Details of the modifications to be made are identified by the designs and dimensions of dormers 50, the selected locations for placement of the dormers 50, and the design of the architectural structure in one embodiment.

Referring to FIG. 4B, exemplary details of non-floating dormers 50a are described. The side walls 54 of the dormer 50a go to the floor and meet with either side of wall 36 illustrated as a kneewall in FIG. 4B. During the integration of the dormers 50a, the dormer side walls 54 run from the respective front walls including windows 56 of the dormers 50a back to the kneewall 36. The portions of the kneewall 36 which intersect with the side walls 54 to be modified are identified and the portions may be broken and the details of dormers 50a may be shown.

According to one embodiment, processing circuitry 14 may also provide error information to a user if problems are identified during the generation and/or integration of the objects. For example, conflicts may arise between the existing design of the architectural structure and the objects. In a more specific example, a user may select placement of a dormer 50, 50a at a location of the design of the architectural structure where an internal wall or framing member is present. Processing circuitry 14 may determine a conflict is present using dimensions of the dormer 50, 50a, the location for placement of the dormer 50, 50a and the information regarding the design of the architectural structure (e.g., location of an interior wall or framing member). In one example, a conflict may be identified if an interior wall is joined to an exterior wall at a location where a dormer is to be inserted. In another example, processing circuitry 14 may determine if a ridge of a dormer 50, 50a extends above a ridge of base roof 52 and results in a conflict. In another example, storage circuitry 16 may also include information regarding applicable building codes and processing circuitry 14 may access the code information to determine if conflicts of the design of the architectural structure are present.

In some implementations, processing circuitry 14 may formulate an error message to indicate the conflict to the user. Processing circuitry 14 may be configured in one embodiment to attempt to resolve the conflicts. For example, the processing circuitry 14 may analyze the design to determine if movement of the dormer 50, 50a in a lateral direction will avoid a wall or frame member, or vice versa. In one embodiment, processing circuitry 14 may automatically attempt to identify a resolution to a conflict in the absence of user input requesting a resolution to the specific identified conflict when the conflict is identified. In one embodiment, processing circuitry 14 may modify a dormer and/or a design of the architectural structure to resolve the conflict. The processing circuitry 14 may inform the user of possible resolutions to conflicts before resolving the conflicts in but one implementation.

According to one embodiment, processing circuitry 14 is configured to automatically implement operations with respect to design of objects and/or integration of objects into a design of an architectural structure including modifying dormers 50, 50a and/or an existing design of an architectural structure to accommodate the dormers 50, 50a. In one example, after a location within the design of the architectural structure is identified for placement of an object (e.g., responsive to user input, default placement determined by processing circuitry 14, etc.), the operations with respect to dormer 50, 50a generation and/or integration may be performed automatically without user instruction instructing the processing circuitry 14 to generate the dormer 50, 50a or integrate the information of the dormer 50, 50a and the design of the architectural structure.

Exemplary operations automatically performed by the processing circuitry 14 include operations with respect to design of the dormer 50, 50a itself including one or more of extraction of information regarding dormers 50, 50a from a library and designing the dormers 50, 50a in the absence of user input specifying the processing circuitry 14 to design the dormers 50, 50a. Additional exemplary automatic operations include extraction of information of the design of the architectural structure where the dormer 50, 50a will be located and/or calculation of dimensions of the subcomponents of the dormer 50, 50a using the extracted information in the absence of user input specifying the processing circuitry 14 to perform the extracting and/or calculating. Additional exemplary operations automatically performed by the processing circuitry 14 include operations with respect to integration of the dormer 50, 50a into the existing design of the architectural structure including for example identifying portions of the design to be modified by the integration (e.g., using location or placement information of the dormer 50, 50a and information regarding the dormer 50, 50a itself) in the absence of user instruction identifying the specific portions of the design to be modified. In addition, the design may thereafter be automatically modified to include the dormer 50, 50a and the modified design including the dormer 50, 50a may be depicted using a display.

In some examples, the processing circuitry may perform one or more of the above-described exemplary automatic operations with respect to dormers 50, 50a after a user has provided instruction to insert dormers 50, 50a (e.g., a user selecting a dormer input mode of operation) or based on a default setting (e.g., to always include dormers 50, 50a into designs of architectural structures).

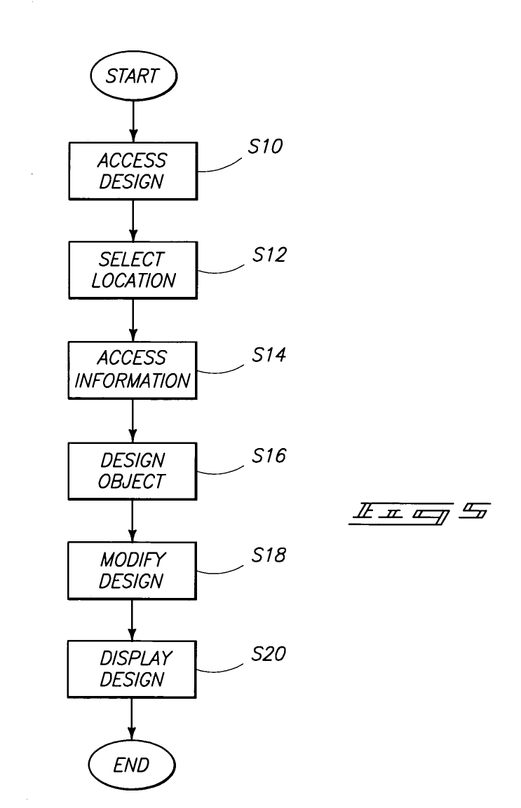

Referring to FIG. 5, an exemplary method for designing and/or integrating an object (e.g., dormer into a design of an architectural structure is shown. The exemplary method may be executed by apparatus 10 in one embodiment. For example, in one embodiment, processing circuitry 14 of apparatus 10 may execute ordered instructions (e.g., software) to implement the depicted method. Other methods are possible including more, less and/or alternative steps.

At a step S10, the processing circuitry may access a design of an architectural structure. The design may be created by a user, accessed from storage circuitry or otherwise appropriately accessed. The processing circuitry may control a display to depict the accessed design at step S10 as well as other steps of FIG. 5 in one implementation.

At a step S12, a desired location of the architectural structure for incorporation of an object is selected or determined. For example, wherein the object comprises a dormer, the selection may include identifying the location on the roof of the design of the architectural structure. The location may be selected responsive to user input or identified by processing circuitry automatically without user input in illustrative examples.

At a step S14, the processing circuitry may access information regarding the design of the architectural structure corresponding to the location selected in step S12. The processing circuitry may access information regarding the object at step S14. For example, the processing circuitry may access information regarding a plurality of assembled subcomponents to form the object and which may be stored within a library in one example.

At a step S16, the processing circuitry may use information of the design of the architectural structure corresponding to the location selected in step S12 as well as information regarding the object (e.g., information from a library specifying aspects of the object) to design the object for specific application into the respective design of the architectural structure and from which information was obtained at step S14.

At a step S18, the processing circuitry may use the information of step S14 and the designed object of step S16 to identify portions of the design of the architectural structure to be modified for integration of the object and to modify the design at the identified portions to include the object.

At a step S20, the processing circuitry may control a display to depict the design of the architectural structure including the integrated object.

In compliance with the statute, the disclosure has been described in language more or less specific as to structural and methodical features. It is to be understood, however, that the disclosure is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

Further, aspects herein have been presented for guidance in construction and/or operation of illustrative embodiments of the disclosure. Applicant(s) hereof consider these described illustrative embodiments to also include, disclose and describe further inventive aspects in addition to those explicitly disclosed: For example, the additional inventive aspects may include less, more and/or alternative features than those described in the illustrative embodiments. In more specific examples, Applicants consider the disclosure to include, disclose and describe methods which include less, more and/or alternative steps than those methods explicitly disclosed as well as apparatus which includes less, more and/or alternative structure than the explicitly disclosed structure.

What is claimed is:

1. An architectural structure design method comprising:
accessing a design of an architectural structure;
accessing information regarding a location of the design of the architectural structure;
designing an object using the information regarding the location;
modifying the design of the architectural structure to include the object; and
after the modifying, displaying the design of the architectural structure comprising the object.

2. The method of claim 1 further comprising selecting the location of the design of the architectural structure for placement of the object responsive to user input and wherein the accessing the information is responsive to the selecting.

3. The method of claim 2 further comprising displaying the design at an initial moment in time before the selecting, and wherein the selecting comprises selecting responsive to user input interacting with the displayed design.

4. The method of claim 1 wherein the modifying comprises integrating the object into the design of the architectural structure at the location.

5. The method of claim 1 wherein the designing comprises automatically designing the object without user input controlling the designing.

6. The method of claim 1 wherein the modifying comprises automatically modifying the design without user input controlling the modifying.

7. The method of claim 1 wherein the object comprises a dormer.

8. The method of claim 7 wherein the dormer comprises a floating dormer.

9. The method of claim 7 wherein the accessing comprises accessing information regarding a pitch of a roof of the design of the architectural structure corresponding to the location and the designing comprises designing the object using the pitch of the roof.

10. The method of claim 1 wherein the accessing comprises accessing information regarding an interior portion of the design of the architectural structure.

11. The method of claim 1 wherein the modifying comprises modifying an interior portion of the design of the architectural structure corresponding to the object.

12. The method of claim 1 wherein the modifying comprises modifying an exterior portion of the design of the architectural structure corresponding to the object.

13. The method of claim 1 wherein the modifying comprises identifying portions of the design of the architectural structure which are affected by the modification from other portions of the design of the architectural structured which are not affected by the modification.

14. The method of claim 1 wherein the object comprises a plurality of subcomponents assembled according to a predefined arrangement.

15. The method of claim 1 further comprising:
providing a library comprising information regarding a plurality of objects, wherein individual ones of the objects include a plurality of predefined subcomponents; and
using the library, selecting the object for integration into the design of the architectural structure.

16. The method of claim 15 further comprising changing one of the predefined subcomponents of the selected object responsive to user input before the modifying.

17. The method of claim 1 further comprising:
detecting an error condition with respect to the modifying; and
indicating the error condition to a user responsive to the detecting.

18. The method of claim 1 further comprising accessing stored information regarding the object and wherein the designing comprises designing using the stored information.

19. An architectural structure design apparatus comprising:
a display configured to depict a design of an architectural structure;
a user interface configured to receive user input; and
processing circuitry coupled with the display and the user interface, wherein the processing circuitry is configured to control the display to depict the design of the architectural structure at a first moment in time, to access one of the user inputs indicative of a desire of the user to insert a dormer into the design of the architectural structure at a second moment in time after the first moment in time, to access information regarding the dormer and information regarding the design of the architectural structure responsive to the accessing the one of the user inputs, to modify the design of the architectural structure to include the dormer, and to control the display to depict the design of the architectural structure including the dormer at a third moment in time after the first and second moments in time.

20. The apparatus of claim 19 wherein the processing circuitry is further configured to design the dormer using the information regarding the design of the architectural structure.

21. The apparatus of claim 20 wherein the processing circuitry is configured to identify a location of a roof of the design of the architectural structure for placement of the dormer, and wherein the processing circuitry is configured to access the information regarding the design pertinent to the location of the roof.

22. The apparatus of claim 21 wherein the processing circuitry is configured to identify the location of the roof responsive to user input.

23. The apparatus of claim 20 wherein the processing circuitry is configured to automatically design the dormer in the absence of user input controlling the design of the dormer.

24. The apparatus of claim 20 wherein the processing circuitry is configured to automatically modify the design of the architectural structure in the absence of user input controlling modifications made to the design.

25. The apparatus of claim 20 wherein the processing circuitry is configured to access the information regarding an interior portion of the design of the architectural structure and to design the dormer using the information regarding the interior portion.

26. The apparatus of claim 19 wherein the processing circuitry is configured to identify portions of the design of the architectural structure which are affected by the modification from other portions of the design of the architectural structured which are not affected by the modification.

27. The apparatus of claim 19 wherein the processing circuitry is configured to modify an interior portion of the design of the architectural structure corresponding to the dormer.

28. The apparatus of claim 19 wherein the processing circuitry is configured to modify an exterior portion of the design of the architectural structure corresponding to the dormer.

29. The apparatus of claim 19 wherein the dormer comprises a floating dormer.

30. The apparatus of claim 19 further comprising storage circuitry configured to store information regarding a plurality of subcomponents assembled in a predefined arrangement corresponding to the dormer.

31. The apparatus of claim 30 wherein the processing circuitry is configured to modify information regarding one of the subcomponents responsive to user input prior to modification of the design of the architectural structure to include the dormer.

32. The apparatus of claim 19 wherein the processing circuitry is configured to detect an error condition with respect to modification:of the design of the architectural structure to include the dormer, and to convey the error condition to a user responsive to the detection.

33. The apparatus of claim 32 wherein the processing circuitry is configured to automatically resolve the error condition in the absence of user input instructing the processing circuitry to perform the resolution.

34. An article of manufacture comprising:
media comprising programming configured to cause processing circuitry to perform processing comprising:
controlling a display to depict a design of an architectural structure at a first moment in time;
accessing user input identifying a location of the design of the architectural structure for placement of a dormer;
accessing information regarding the dormer;
identifying portions of the architectural structure to be modified using the location and the information regarding the dormer;
modifying the portions of the design of the architectural structure to integrate the dormer with the design of the architectural structure; and
controlling the display to depict the design of the architectural structure having the dormer at a second moment in time after the first moment in time.

35. The article of claim 34 wherein the media further comprises programming configured to cause processing circuitry to perform processing comprising:
accessing information regarding the design of the architectural structure corresponding to the location; and
designing the dormer using the information regarding the design of the architectural structure.

36. The article of claim 35 wherein the media further comprises programming configured to cause processing circuitry to perform processing comprising accessing information regarding a construction of the dormer and wherein the designing comprises designing using the information regarding the construction of the dormer.

37. The article of claim 34 wherein the identifying comprises identifying using the information regarding the dormer.

38. The article of claim 34 wherein the media further comprises programming configured to cause processing circuitry to perform processing comprising automatically performing the modifying of the portions of the design of the architectural structure in the absence of user input specifying the modifications to be made.
